(19) United States
(12) Patent Application Publication
(10) Pub. No.: US 2020/0017207 A1
(43) Pub. Date: Jan. 16, 2020

(54) ROTARY WING AIRCRAFT WITH ENHANCED YAW CAPABILITY

(71) Applicant: Sikorsky Aircraft Corporation, Stratford, CT (US)

(72) Inventor: Mark R. Alber, Milford, CT (US)

(21) Appl. No.: 16/034,017

(22) Filed: Jul. 12, 2018

(51) Int. Cl. B64C 27/82; B64C 27/06; B64C 27/78

(52) U.S. Cl. CPC B64C 27/82; B64C 27/06; B64C 27/78; B64C 2027/8209; B64C 2027/8281; B64C 2027/8236; B64C 2027/8254

(57) ABSTRACT

A yaw control system of an aircraft includes an aircraft having an airframe extending along a longitudinal axis, a coaxial contra-rotating main rotor system rotatable about a first axis, and a rotor system rotatable about a second axis to move air between a first side of the airframe and a second, opposite side of the airframe. The first side and the second side are disposed on opposing sides of the longitudinal axis. The yaw control provided by operation of the rotor system is supplemental to the yaw control provided by the coaxial contra-rotating main rotor system.

### BACKGROUND

The subject matter disclosed herein relates to a rotary wing aircraft, and more particularly, to yaw control of a rotary wing aircraft having a dual, counter-rotating, coaxial rotor system.

A rotary wing aircraft, such as a helicopter, with a coaxial contra-rotating rotor system, is capable of higher speeds than conventional single rotor rotary wing aircraft in part due to the balance of lift between advancing sides of the main rotor blades on the upper and lower rotor systems. Such aircraft, however, can have limited yaw control during hover, lower speed flight conditions, low thrust conditions, autorotation and ground handling. The limited yaw performance is typically due to the inability of the aircraft to create adequate differential rotor torque between the two coaxial rotors under these flight conditions and the inability of the tail surfaces to provide adequate yaw control at low speeds. The aircraft sometimes includes large rudders which may be used to compensate for the reduced yaw control.

### BRIEF DESCRIPTION

According to an embodiment, a yaw control system of an aircraft includes an aircraft having an airframe extending along a longitudinal axis, a coaxial contra-rotating main rotor system rotatable about a first axis, and a rotor system rotatable about a second axis to move air between a first side of the airframe and a second, opposite side of the airframe. The first side and the second side are disposed on opposing sides of the longitudinal axis. The yaw control provided by operation of the rotor system is supplemental to the yaw control provided by the coaxial contra-rotating main rotor system.

In addition to one or more of the features described above, or as an alternative, in further embodiments rotation of the rotor system in a first direction moves air from the first side of the airframe to the second side of the airframe to provide yaw control to the aircraft in a first direction.

In addition to one or more of the features described above, or as an alternative, in further embodiments rotation of the rotor system in a second direction moves air from the second side of the airframe to the first side of the airframe to provide yaw control to the aircraft in a second direction.

In addition to one or more of the features described above, or as an alternative, in further embodiments comprising an opening formed in the airframe extending between the first side and the second side, the rotor system being mounted within the opening.

In addition to one or more of the features described above, or as an alternative, in further embodiments the rotor system is selectively rotatable about the second axis by a power source, the power source being selected from a battery, generator, and engine.

In addition to one or more of the features described above, or as an alternative, in further embodiments operation of the rotor system is based on a flight condition of the aircraft.

In addition to one or more of the features described above, or as an alternative, in further embodiments the rotor system is operable during low speed flight.

In addition to one or more of the features described above, or as an alternative, in further embodiments the rotor system is operable during autorotation.

In addition to one or more of the features described above, or as an alternative, in further embodiments the rotor system is operable during ground handling.

In addition to one or more of the features described above, or as an alternative, in further embodiments comprising a system for providing thrust adjacent a tail of the airframe.

In addition to one or more of the features described above, or as an alternative, in further embodiments the system for providing thrust includes a propeller rotatable about a third axis oriented substantially parallel to the longitudinal axis.

According to another embodiment, an aircraft includes an airframe having a tail, a primary yaw control mechanism, and a secondary yaw control mechanism configured to move air between a first side and a second side of the airframe. The secondary yaw control mechanism is operable to supplement yaw control provided by the primary yaw control mechanism.

In addition to one or more of the features described above, or as an alternative, in further embodiments the primary yaw control mechanism includes a coaxial main rotor system.

In addition to one or more of the features described above, or as an alternative, in further embodiments comprising a flight control computer operably coupled to at least one of the primary yaw control mechanism and the secondary yaw control mechanism.

In addition to one or more of the features described above, or as an alternative, in further embodiments the flight control computer operates the secondary yaw control mechanism to supplement yaw control provided by the primary yaw control mechanism when a differential collective of the primary yaw control mechanism is insufficient for operation of the aircraft.

In addition to one or more of the features described above, or as an alternative, in further embodiments the flight control computer operates the secondary yaw control mechanism to supplement yaw control provided by the primary yaw control mechanism when the aircraft is in low speed flight.

In addition to one or more of the features described above, or as an alternative, in further embodiments the flight control computer operates the secondary yaw control mechanism to supplement yaw control provided by the primary yaw control mechanism when the aircraft is autorotating.

In addition to one or more of the features described above, or as an alternative, in further embodiments the secondary yaw control mechanism includes a rotor system rotatable about an axis to move air between the first side of the airframe and the second, opposite side of the airframe.

In addition to one or more of the features described above, or as an alternative, in further embodiments the rotor system is mounted within an opening formed in the airframe.

In addition to one or more of the features described above, or as an alternative, in further embodiments rotation of the rotor system in a first direction moves air from a first side of the aircraft to the second side of the aircraft to provide yaw control to the aircraft in a first direction and rotation of the rotor system in a second direction moves air from the second side of the aircraft to the first side of the aircraft to provide yaw control to the aircraft in a second direction.

In addition to one or more of the features described above, or as an alternative, in further embodiments the rotor system includes a plurality of blades having a variable pitch, the rotor system being operable in a single direction.

In addition to one or more of the features described above, or as an alternative, in further embodiments adjusting the pitch of the plurality of blades in a first direction in provides yaw control to the aircraft in a first direction and adjusting the pitch of the plurality of blades in a second direction provides yaw control to the aircraft in a second, opposite direction.

In addition to one or more of the features described above, or as an alternative, in further embodiments the aircraft further comprises at least one door movable between an open position and a closed position to selectively operate the secondary yaw control mechanism.

### BRIEF DESCRIPTION OF THE DRAWINGS

The following descriptions should not be considered limiting in any way. With reference to the accompanying drawings, like elements are numbered alike:

FIG. 1 is a side view of a rotary wing aircraft according to an embodiment;

FIG. 2 is a perspective view of a rotary wing aircraft according to an embodiment;

FIG. 3 is a side view of a tail section of a rotary wing aircraft according to an embodiment; and

FIG. 4 is another side view of a tail section of a rotary wing aircraft according to an embodiment.

### DETAILED DESCRIPTION

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

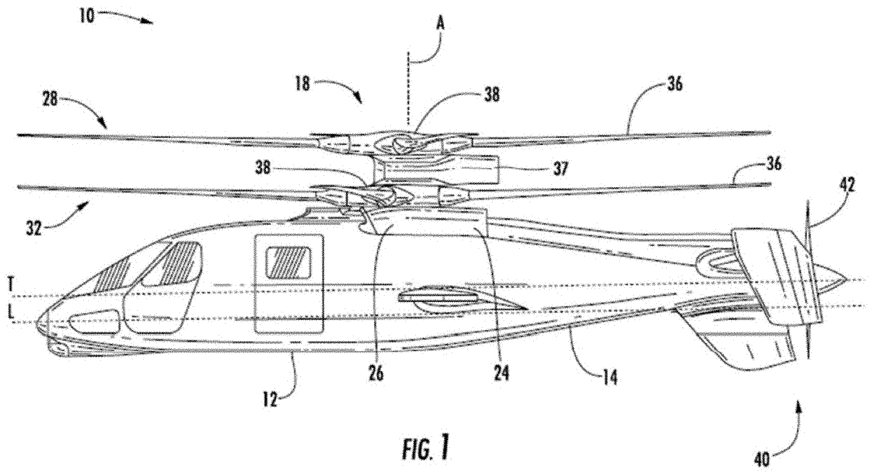

FIG. 1 depicts an exemplary embodiment of a rotary wing, vertical takeoff and land (VTOL) aircraft 10. The aircraft 10 includes an airframe 12 with an extending tail 14. A dual, counter rotating, coaxial main rotor assembly 18 is located at the airframe 12 and rotates about a main rotor axis, A. In an embodiment, the airframe 12 includes two seats for flight crew (e.g., pilot and co-pilot) and six seats for passengers. The main rotor assembly 18 is driven by a power source, for example, one or more engines 24 via a gearbox 26. The main rotor assembly 18 includes an upper rotor assembly 28 driven in a first direction (e.g., counter-clockwise) about the main rotor axis, A, and a lower rotor assembly 32 driven in a second direction (e.g., clockwise) about the main rotor axis, A, opposite to the first direction (i.e., counter rotating rotors). Each of the upper rotor assembly 28 and the lower rotor assembly 32 includes a plurality of rotor blades 36 secured to a rotor hub 38. In some embodiments, the aircraft 10 further includes a translational thrust system 40 located at the extending tail 14 to provide translational thrust (forward or rearward) for aircraft 10.

Any number of blades 36 may be used with the rotor assembly 18. The rotor assembly 18 includes a rotor hub fairing 37 generally located between and around the upper and lower rotor assemblies such that the rotor hubs 38 are at least partially contained therein. The rotor hub fairing 37 provides drag reduction. Rotor blades 36 are connected to the upper and lower rotor hubs 38 in a hingeless manner, also referred to as a rigid rotor system. Although a particular aircraft configuration is illustrated in this non-limiting embodiment, other rotary-wing aircraft are also within the scope of this disclosure. Although, the dual rotor system is depicted as coaxial, embodiments include dual rotor aircraft having non-coaxial rotors.

In the illustrated, non-limiting embodiment, the translational thrust system 40 includes a propeller 42 connected to and driven by the engine 24 via the gearbox 26. The translational thrust system 40 may be mounted to the rear of the airframe 12 with a translational thrust axis, T, oriented substantially horizontal and parallel to the aircraft longitudinal axis, L, to provide thrust for high-speed flight. The translational thrust axis, T, corresponds to the axis of rotation of propeller 42. While shown in the context of a pusher-prop configuration, it is understood that the propeller 42 could also be more conventional puller prop or could be variably facing so as to provide yaw control in addition to or instead of translational thrust. Further, it should be understood that any such system or other translational thrust systems, such as the thrust systems used in aircraft having “no tail rotor also referred to as “NOTAR” may alternatively or additionally be utilized. Alternative translational thrust systems may include different propulsion forms, such as a jet engine.

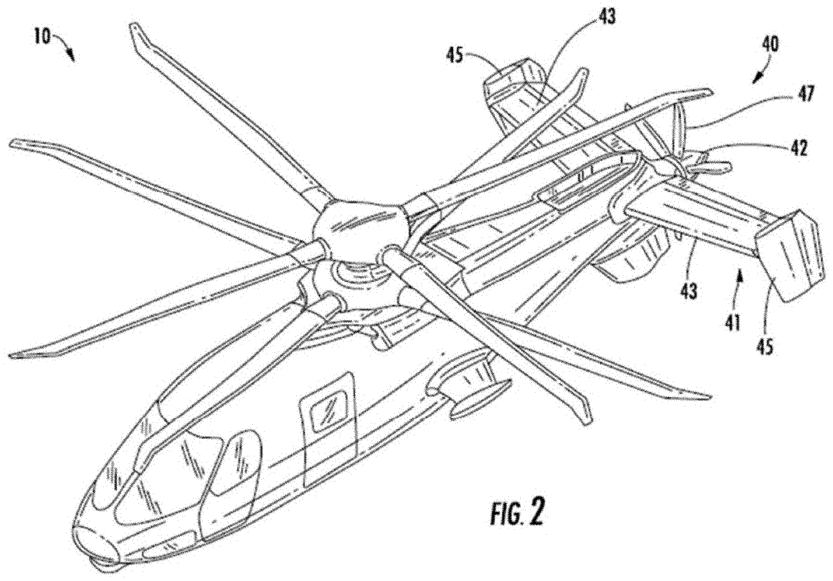

Referring to FIG. 2, translational thrust system 40 includes a propeller 42 and is positioned at a horizontally oriented tail section 41 of the aircraft 10. Propeller 42 includes a plurality of blades 47. In an embodiment, the pitch of propeller blades 47 may be altered to change the direction of thrust (e.g., forward or rearward). The tail section 41 includes elevators 43 and rudders 45 as controllable surfaces.

Differential collective of the coaxial counter-rotating main rotor assembly 18 may be used to provide primary yaw control to the aircraft 10. However, the differential collective, and therefore the yaw control provided by the coaxial counter-rotating main rotor assembly 18 may be weak or limited in certain flight conditions. Cyclic pitch control may be applied to the propeller blades 47 of the translational thrust system 40 to improve the yaw response of the aircraft 10 in select flight conditions, such as during high speed flight. In applying cyclic pitch control, a pitch of each propeller blade 47 about a respective pitch axis is varies as the propeller blade 47 rotates about the propeller rotational axis T. Alternatively, or in addition, the active rudders 45 may be used to provide primary yaw control. However, in other flight conditions, such as when the aircraft 10 is in flight at slower speeds (i.e. flight at less than 60 nautical miles per hour) or during autorotation for example, the primary yaw control provided by the main rotor assembly 18 is limited and the translational thrust system 40 may or may not be operational.

In an embodiment, the aircraft 10 includes a mechanism 50 for providing secondary yaw control. The secondary yaw control mechanism 50 is selectively operable to supplement or enhance the yaw provided by the primary yaw control, i.e. one or both of the main rotor assembly 18 and the translational thrust system 40.

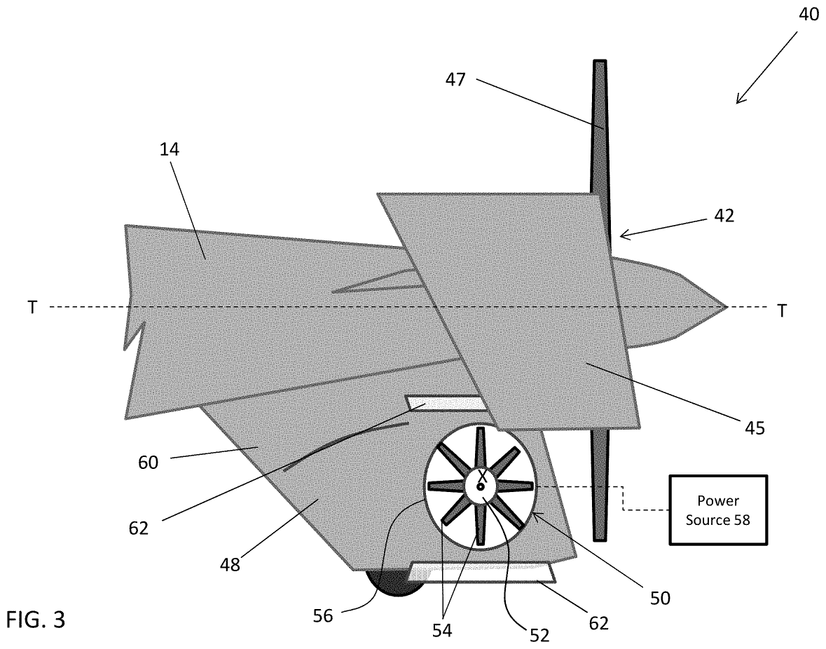

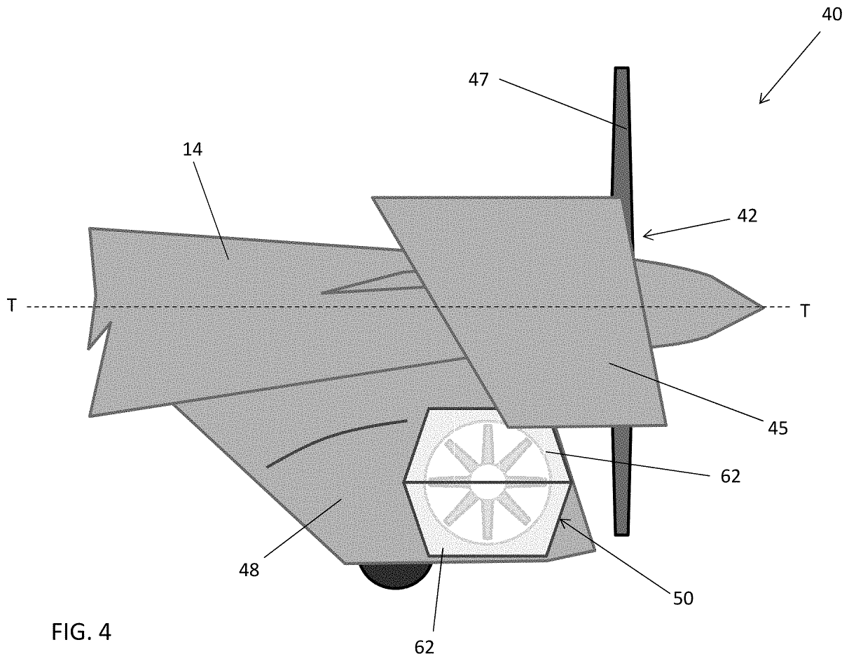

With reference now to FIGS. 3 and 4, the aircraft 10 may additionally include a fin 48 extending generally vertically downward from either the extending tail section 14 or the horizontal tail section 41. In an embodiment, the fin 48 is centrally located in axial alignment with the translational thrust axis T. The fin 48 may extend generally perpendicularly from the translational thrust axis T of the aircraft 10, parallel to the active rudders 45.

In the illustrated, non-limiting embodiment, the mechanism 50 is a rotor or fan including a hub 52 having a plurality of blades 54 coupled thereto. As shown, the rotor 50 may be arranged within a through opening 56 formed in the central fin 48, such that an overall thickness of the rotor 50 is equal to or less than the thickness of the fin 48. The rotor 50 is rotatable about a fan axis X, extending between the rudders 45, substantially perpendicular to the translational thrust axis T. However, it should be understood that a rotor mounted at another location, such as offset from the airframe for example such that air is movable via the mechanism 50 between opposing sides of the airframe is also within the scope of the disclosure.

A power source, such as a motor illustrated schematically at 58, is coupled to the rotor 50 operably to rotate the fan about the fan axis X. In an embodiment, the power source may be the shaft of the translational thrust system 40 or another component coupled thereto such that rotation of the translational thrust system 40 about the translational thrust axis T drives a similar rotation of the rotor 50 about its axis X. In another embodiment, the power source 58 includes a generator and/or battery. As a result, the secondary yaw control mechanism 50 is operable independently of the primary yaw control. The generator and/or battery may be sized to provide the power necessary for an entire mission or flight. Alternatively, the battery may be rechargeable in flight, such as via a generator driven by an engine for example.

The power source 58 may be controlled to drive the secondary yaw control mechanism 50 about its axis X in a single one direction. In such embodiments, thrust would be provided by varying the blade pitch to draws air from adjacent a first side 60 of the central fin 48 through the rotor 50 and expels or exhausts that air adjacent the second, opposite side (not shown) of the central fin 48. This movement of air provides supplemental yaw control in a first direction. Similarly, varying blade pitch in the other direction draws air from adjacent the second side (not shown) of the central fin 48 through the rotor 50 and exhausts the air adjacent the first side 60 of the central fin 48. Movement of air in this second direction provides supplemental yaw control to the aircraft 10 in a corresponding second direction.

Alternatively, the power source 58 may be controlled to drive the secondary yaw control mechanism 50 about its axis X in both a first direction and a second, opposite direction. Rotation in a first direction draws air from adjacent a first side 60 of the central fin 48 through the rotor 50 and expels or exhausts the air adjacent the second, opposite side (not shown) of the central fin 48. This movement of air in first direction provides supplemental yaw control in a first direction. Similarly, rotation of the secondary yaw control mechanism 50 in the second direction draws air from adjacent the second side (not shown) of the central fin 48 through the rotor 50 and exhausts the air adjacent the first side 60 of the central fin 48. Movement of air in this second direction provides supplemental yaw control to the aircraft 10 in a corresponding second direction.

The opening 56 in which the rotor 50 is positioned may be selectively sealable. In an embodiment, best shown in FIG. 4, the aircraft 10 may include one or more doors 62 disposed adjacent each side of the opening 58. The doors 62 are movable between an open position (FIG. 3) and a closed position (FIG. 4) depending on the operating condition of the aircraft 10 and/or the operational status of the rotor 50. For example, the doors 62 are typically in an open position when the secondary yaw control mechanism 50 is operational and may be in the closed position when the mechanism 50 is non-operational. Maintaining the doors 62 in a closed position when the secondary yaw control mechanism 50 is not in use may improve the aerodynamics of the aircraft 10. Although two doors 62 that cooperate to seal a first side of the opening 56 are shown in the FIG., embodiments including only a single door, or alternatively, more than two doors, are also within the scope of the disclosure.

Enhanced control of the aircraft is achieved by selectively operating the secondary yaw control mechanism 50 to supplement the yaw control provided by a primary yaw control mechanism during certain flight conditions. This provides an operator of the aircraft 10 with positive yaw control throughout the entire flight regime, including autorotation and ground handling, without negatively affecting a cruise flight of the aircraft 10.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A yaw control system of an aircraft comprising:
an aircraft having an airframe extending along a longitudinal axis;
a coaxial contra-rotating main rotor system rotatable about a first axis; and
a rotor system rotatable about a second axis to move air between a first side of the airframe and a second, opposite side of the airframe, the first side and the second side being disposed on opposing sides of the longitudinal axis, wherein yaw control provided by operation of the rotor system is supplemental to the coaxial contra-rotating main rotor system.

2. The yaw control system of claim 1, wherein rotation of the rotor system in a first direction moves air from the first side of the airframe to the second side of the airframe to provide yaw control to the aircraft in a first direction.

3. The yaw control system of claim 2, wherein rotation of the rotor system in a second direction moves air from the second side of the airframe to the first side of the airframe to provide yaw control to the aircraft in a second direction.

4. The yaw control system of claim 1, further comprising an opening formed in the airframe extending between the first side and the second side, the rotor system being mounted within the opening.

5. The yaw control system of claim 1, wherein the rotor system is selectively rotatable about the second axis by a power source, the power source being selected from a battery, generator, and engine.

6. The yaw control system of claim 1, wherein operation of the rotor system is based on a flight condition of the aircraft.

7. The yaw control system of claim 6, wherein the rotor system is operable during low speed flight.

8. The yaw control system of claim 6, wherein the rotor system is operable during autorotation.

9. The yaw control system of claim 6, wherein the rotor system is operable during ground handling.

10. The yaw control system of claim 1, further comprising a system for providing thrust adjacent a tail of the airframe.

11. The yaw control system of claim 10, wherein the system for providing thrust includes a propeller rotatable about a third axis oriented substantially parallel to the longitudinal axis.

12. An aircraft comprising:
an airframe having a tail;
a primary yaw control mechanism;
a secondary yaw control mechanism configured to move air between a first side and a second side of the airframe, wherein the secondary yaw control mechanism is operable to supplement yaw control provided by the primary yaw control mechanism.

13. The aircraft of claim 12, wherein the primary yaw control mechanism includes a coaxial main rotor system.

14. The aircraft of claim 12, further comprising a flight control computer operably coupled to at least one of the primary yaw control mechanism and the secondary yaw control mechanism.

15. The aircraft of claim 14, wherein the flight control computer operates the secondary yaw control mechanism to supplement yaw control provided by the primary yaw control mechanism when a differential collective of the primary yaw control mechanism is insufficient for operation of the aircraft.

16. The aircraft of claim 14, wherein the flight control computer operates the secondary yaw control mechanism to supplement yaw control provided by the primary yaw control mechanism when the aircraft is in low speed flight.

17. The aircraft of claim 14, wherein the flight control computer operates the secondary yaw control mechanism to supplement yaw control provided by the primary yaw control mechanism when the aircraft is autorotating.

18. The aircraft of claim 12, wherein the secondary yaw control mechanism includes a rotor system rotatable about an axis to move air between the first side of the airframe and the second, opposite side of the airframe.

19. The aircraft of claim 17, wherein the rotor system is mounted within an opening formed in the airframe.

20. The aircraft of claim 17, wherein rotation of the rotor system in a first direction moves air from a first side of the aircraft to the second side of the aircraft to provide yaw control to the aircraft in a first direction and rotation of the rotor system in a second direction moves air from the second side of the aircraft to the first side of the aircraft to provide yaw control to the aircraft in a second direction.

21. The aircraft of claim 17, wherein the rotor system includes a plurality of blades having a variable pitch, the rotor system being operable in a single direction.

22. The aircraft of claim 21, wherein adjusting the pitch of the plurality of blades in a first direction in provides yaw control to the aircraft in a first direction and adjusting the pitch of the plurality of blades in a second direction provides yaw control to the aircraft in a second, opposite direction.

23. The aircraft of claim 16, wherein the aircraft further comprises at least one door movable between an open position and a closed position to selectively operate the secondary yaw control mechanism.
